(19) United States
(12) Patent Application Publication
(10) Pub. No.: US 2015/0064430 A1
(43) Pub. Date: Mar. 5, 2015

(54) HEAT INSULATION LAYER SYSTEM WITH CORROSION AND EROSION PROTECTION

(71) Applicant: MTU Aero Engines AG, Munich (DE)

(72) Inventor: Philipp DOEBBER, Hannover (DE)

(21) Appl. No.: 14/475,737

(22) Filed: Sep. 3, 2014

(30) Foreign Application Priority Data
Sep. 4, 2013 (DE) 102013217627.9

(51) Int. Cl. F16L 59/02

(52) U.S. Cl. CPC F16L 59/029
USPC 428/215; 428/697; 428/472; 428/446; 428/332

(57) ABSTRACT

Disclosed is a heat insulation layer system for metallic components, in particular for components stressed by high temperatures and/or hot gas, of a flow machine, having at least one heat insulation layer of a material comprising at least one component having at least one phase which stoichiometrically contains from 1 to 80 mol % of Mx₂O₃, from 0.5 to 80 mol % of MyO with Al₂O₃ and unavoidable impurities as balance, where Mx is selected from the elements lanthanum, neodymium, chromium or mixtures thereof and My is selected from alkaline earth metals, transition metals, rare earths or mixtures thereof, where an Al₂O₃ layer is present on the at least one heat insulation layer on the side facing away from the component.

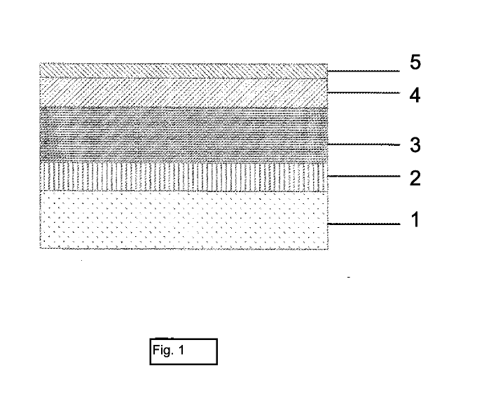

### CROSS-REFERENCE TO RELATED APPLICATIONS

The present application claims priority under 35 U.S.C. §119 of German Patent Application No. 102013217627.9, filed Sep. 4, 2013, the entire disclosure of which is expressly incorporated by reference herein.

### BACKGROUND OF THE INVENTION

1. Field of the Invention

The present invention relates to a heat insulation layer system for a metallic component and also to a corresponding component.

2. Discussion of Background Information

Turbomachines, such as stationary gas turbines and aircraft engines, are being operated at ever higher combustion temperatures in order to increase the efficiency, so that components in regions which are exposed to hot gas in the combustion chamber and the high-pressure turbine have to be protected by active cooling and heat insulation layer systems.

Known heat insulation layer systems (HILS) comprise a metallic bonding layer which at the same time serves as oxidation and corrosion protection layer and also displays improved adhesion to a ceramic layer arranged on the outside of the HILS. Bonding layers are generally based on aluminum layers or platinum-aluminum layers and also MCrAlY alloys, where M is a metal such as nickel, cobalt or iron. The ceramic covering layers usually consist of zirconium oxide stabilized with magnesium, calcium or yttrium or yttrium oxide (YSZ, yttrium-stabilized zirconium oxide).

Although such heat insulation layers have excellent properties, there are problems in that aircraft engines can be subjected to tremendous stress due to sand and dust, for example ash particles or industrially produced dusts. These liquefy at high temperatures and interact thermomechanically and thermochemically with the HILS by infiltration into microcracks and open pores in the outer ceramic layer. This results in decomposition and embrittlement and thus to corresponding failure of the heat insulation layer, so that the components protected by the heat insulation layer have to be replaced or repaired. This leads to a considerable financial outlay, so that protection of the heat insulation layers from damage by sand and dust melts is necessary.

Measures for protecting heat insulation layers from damage by sand melts are known from the prior art, with arrangement of reactive oxides above or in the outer region of the ceramic layer of the heat insulation layer being intended to effect protection by reaction of the melt with the reactive oxides forming a stable crystalline layer on top of the heat insulation layer and protecting the latter against further attack by sand melts. Examples of such protective measures are given in US 2004/0170849 A1, EP 1 428 902 A1, U.S. Pat. No. 5,660,885, U.S. Pat. No. 7,780,832 B2, EP 0 783043 A1, U.S. Pat. No. 5,338,577 A and U.S. Pat. No. 7,833,586 B2.

Furthermore, an HILS in which the ceramic layer is configured as a double-layer system and which is more sintering resistant than the YSZ layer system is known from U.S. Pat. No. 7,445,851 B2. Here, an outer covering layer composed of an aluminate is provided in addition to the partially stabilized zirconium oxide layer. This covering layer, which is preferably composed of lanthanum hexaaluminate (LHA) having a magnetoplumbite structure, is particularly resistant to sintering together at high temperatures and is therefore suitable as heat insulation layer on combustion chamber and turbine components in the hot gas stream.

In the patent family of U.S. Pat. No. 8,153,274 B2, the abovementioned LHA layer system is supplemented by an additional erosion protection layer which consists of YSZ and protects the sintering-resistant and reactive LHA layer from removal of material by erosion.

Proceeding from the above, it is desirable to provide a combined corrosion and erosion protective layer for combustion chamber and turbine components in aircraft engines and stationary gas turbines, which offers effective protection against removal of material by erosion and at the same time provides protection against corrosive attack by sand melts and dust melts. In addition, components of this type which can be produced simply and reliably should be provided.

### SUMMARY OF THE INVENTION

The present invention provides a heat insulation layer system and components having the features indicated in the independent claims. Advantageous embodiments are subject matter of the dependent claims.

The invention proceeds from the idea that an additional aluminum oxide layer is applied on top of a heat insulation layer of a material which comprises at least one component having at least one phase which stoichiometrically contains from 1 to 80 mol % of Mx₂O₃, from 0.5 to 80 mol % of MyO with Al₂O₃ and unavoidable impurities as balance, where Mx is selected from among the elements lanthanum, neodymium, chromium or mixtures thereof and My is selected from among alkaline earth metals, transition metals, rare earths or mixtures thereof. Such a layer of the heat insulation layer system will hereinafter be referred to both simply as heat insulation layer and also as aluminate heat insulation layer.

The aluminum oxide layer can, in particular, be provided over an LHA layer and instead of the YSZ layer mentioned in U.S. Pat. No. 8,153,274 B2, so that not only erosion protection but especially also protection against corrosion by sand melts and dust melts and also by sulfate attack is achieved.

The background to the invention is that a high aluminum oxide content of the aluminate heat insulation layer, in particular the lanthanum hexaaluminate layer, preferably in combination with lanthanum oxide, slows the infiltration of the sand melt compared to the YSZ of the standard layer system by means of appropriate reactions and phase transformations of the melt at relatively high melt temperatures. In this way, the operating time of the layer system and component is correspondingly increased. However, the reaction is not completely stopped but merely slowed by the high proportion of the aluminum and lanthanum oxide particles bound in the preferred magnetoplumbite structure, but with the more sintering-resistant magnetoplumbite structure being able to be kept stable.

Now, the infiltration of the sand melt can be completely stopped by an additional layer of Al₂O₃ above the aluminate heat insulation layer, in particular above the LHA layer. Owing to unbound Al₂O₃ particles in the uppermost covering layer, crystallization of the sand melt commences above the aluminate heat insulation layer and crystallization is complete within the aluminate heat insulation layer. Infiltration of the melt into the heat insulation layer system is thus prevented.

A further advantage of the Al₂O₃ layer is protection of the aluminate heat insulation layer against sulfate attack. The lanthanum oxide which is preferably present in the aluminate heat insulation layer is, for example, susceptible to corrosion in the presence of sulfur-containing substances and is accordingly decomposed. An Al₂O₃ covering layer located on top prevents the corrosive attack and protects the aluminate heat insulation layer.

In addition, an Al₂O₃ covering layer additionally present above the aluminate heat insulation layer offers protection against erosion of the aluminate heat insulation layer. Owing to the high hardness, Al₂O₃ layers offer excellent protection against removal of material by erosion.

In the aluminate heat insulation layer, the constituent My can be, in particular, selected from magnesium, zinc, cobalt, manganese, iron, nickel, chromium, europium, samarium or mixtures thereof.

The at least one phase of the aluminate heat insulation layer can preferably stoichiometrically have from 2 to 20 mol %, in particular from 5 to 9 mol % of Mx₂O₃, from 5 to 25 mol %, in particular from 12 to 17 mol %, of MyO with aluminum oxide as balance, with the phase being able to be, in particular, a lanthanum hexaaluminate phase having a magnetoplumbite structure, as mentioned above.

The heat insulation layer system can have, in addition to the aluminate heat insulation layer described and the aluminum oxide layer arranged thereon in the direction of the outside, at least one further inner sublayer arranged between the component and the heat insulation layer, with the inner sublayer being a ceramic layer which can comprise, in particular, zirconium oxide and/or partially or fully stabilized zirconium oxide. The stabilization of the zirconium oxide can be effected by means of yttrium, yttrium oxide, calcium or magnesium.

Furthermore, a bonding layer which can be formed by a metallic layer can be provided between the inner sublayer and the component. The metallic layer can preferably be an aluminum layer, a platinum-aluminum layer or an MCrAlY layer, where M is iron, nickel or cobalt. The aluminum layer and the platinum-aluminum layer can be configured as diffusion layers which can be applied to the component by means of a diffusion process.

The aluminum oxide layer on the outside of the heat insulation layer comprises predominantly aluminum oxide, in particular more than 50 mol % of aluminum oxide, preferably at least 60 mol % of aluminum oxide.

In addition, the aluminum oxide layer can have further constituents, namely one or more elements such as magnesium, calcium, silicon, titanium, chromium, manganese, hafnium, tantalum, platinum, cerium, neodymium, gadolinium, dysprosium and lanthanum as well as oxides thereof. It can also contain zirconium oxide, stabilized or partially stabilized zirconium oxide and mixtures of the abovementioned elements and compounds. The zirconium oxide can, like the inner sublayer, be stabilized by means of yttrium, yttrium oxide, calcium or magnesium.

The aluminum oxide layer, the heat insulation layer, the inner sublayer and/or the bonding layer can each have a layer thickness in the range from 0.1 to 1000 μm, in particular from 0.2 to 500 μm.

The heat insulation layer system can have a plurality of heat insulation layers and/or a plurality of inner sublayers and/or a plurality of aluminum oxide layers which can be present, for example, repeatedly in the order inner sublayer, heat insulation layer and aluminum oxide layer from the inside to the outside in the heat insulation layer system. In addition, a plurality of these layers can also be arranged in any order in the heat insulation layer system.

The heat insulation layer system according to the invention and the metallic bonding layer, the inner sublayer, the heat insulation layer and the aluminum oxide layer can be applied to the component by thermal spraying or by physical vapor deposition (PVD) or electron beam physical vapor deposition (EB-PVD) or chemical vapor deposition (CVD). The preferred but not exclusively possible processes for thermal spraying are plasma spraying, wire flame spraying, electric arc spraying, powder flame spraying, high-velocity flame spraying, laser spraying, cold gas spraying, melt bath spraying, detonation spraying and variants thereof.

The component onto which a heat insulation layer system according to the invention is applied is preferably formed by a metal but can also be configured as metal-ceramic composite, so that the component substrate surface to which the heat insulation layer system is applied can be metallic or mixed metallic-ceramic.

The component can be, in particular, a component of a gas turbine, in particular an aircraft engine, or part of a combustion chamber or turbine component of a gas turbine, in particular an aircraft engine.

### BRIEF DESCRIPTION OF THE DRAWING

The accompanying FIGURE shows, in a purely schematic fashion, a partial section through a component according to the invention having a heat insulation layer system.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawing making apparent to those of skill in the art how the several forms of the present invention may be embodied in practice.

The accompanying FIGURE shows an embodiment of a heat insulation layer system according to the invention in partial cross section on a corresponding component substrate 1 to form a component according to the invention, for example a turbine blade or a combustion chamber lining. The component substrate 1 can be a metallic material or a metal-ceramic composite. A bonding layer 2, which can be configured as aluminum diffusion layer or as Al—Pt diffusion layer, is present on the component substrate 1. The corresponding bonding layer 2 is correspondingly deposited on the component substrate 1 by diffusion processes.

Above the bonding layer, there is, in the direction of the side facing away from the component substrate 1, an inner sublayer 3 of a ceramic material, for example of stabilized or partially stabilized zirconium oxide, with yttrium-partially-stabilized zirconium oxide preferably being used in the example shown.

An aluminate heat insulation layer 4, which can preferably be formed by lanthanum hexaaluminate having a magnetoplumbite structure, is provided on the side of the inner sublayer 3 facing away from the component substrate 1.

In the example shown, an aluminum oxide layer 5, which in the example shown can be a pure aluminum oxide layer, is applied as outer covering layer on the aluminate heat insulation layer 4 to complete the system.

While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

In the case of the indicated compositions of materials, it is clear that these materials can additionally have unavoidable impurities, even when these are not explicitly mentioned. In addition, it likewise goes without saying that the indicated compositions have to be selected so that the individual constituents add up to 100%. In the case of an overlapping composition range, the proportions have to be adapted appropriately, i.e. when one component is selected at the maximum end of the composition range, the other component accordingly has to be selected in the lower composition range if the composition would otherwise exceed 100%.

1.-14. (canceled)

15. A heat insulation layer system for a metallic component, wherein the system comprises at least one heat insulation layer of a material which comprises at least one component having at least one phase which stoichiometrically contains from 1 to 80 mol % of Mx₂O₃, from 0.5 to 80 mol % of MyO, the balance being Al₂O₃ and unavoidable impurities, where Mx represents one or more of lanthanum, neodymium, chromium and My is selected from one or more of alkaline earth metals, transition metals, rare earth metals, and wherein an Al₂O₃ layer is present on the at least one heat insulation layer on a side which is intended to face away from the component.

16. The heat insulation layer system of claim 15, wherein My represents one or more of magnesium, zinc, cobalt, manganese, iron, nickel, chromium, europium, samarium.

17. The heat insulation layer system of claim 15, wherein the at least one phase stoichiometrically comprises from 2 to 20 mol % of Mx₂O₃ and from 5 to 25 mol % of MyO, with Al₂O₃ as balance.

18. The heat insulation layer system of claim 15, wherein the at least one phase stoichiometrically comprises from 5 to 9 mol % of Mx₂O₃ and from 12 to 17 mol % of MyO, with Al₂O₃ as balance.

19. The heat insulation layer system of claim 15, wherein the at least one phase is a lanthanum hexaaluminate having a magnetoplumbite structure.

20. The heat insulation layer system of claim 15, wherein the heat insulation layer system further comprises at least one inner sublayer which is intended to be arranged between the component and the at least one heat insulation layer, which inner sublayer comprises zirconium oxide and/or a partially or fully stabilized zirconium oxide.

21. The heat insulation layer system of claim 20, wherein a bonding layer is arranged on the inner sublayer on a side thereof which is intended to face the component.

22. The heat insulation layer system of claim 21, wherein the bonding layer is a metallic layer.

23. The heat insulation layer system of claim 22, wherein the metallic layer is an aluminum layer, a platinum-aluminum layer or a MCrAlY layer, where M is Fe, Ni or Co.

24. The heat insulation layer system of claim 15, wherein the Al₂O₃ layer comprises predominantly Al₂O₃.

25. The heat insulation layer system of claim 24, wherein the Al₂O₃ layer comprises more than 50 mol % of Al₂O₃.

26. The heat insulation layer system of claim 24, wherein the Al₂O₃ layer comprises at least 60 mol % of Al₂O₃.

27. The heat insulation layer system of claim 15, wherein the Al₂O₃ layer comprises one or more constituents selected from magnesium, calcium, silicon, titanium, chromium, manganese, hafnium, tantalum, platinum, cerium, neodymium, gadolinium, dysprosium, lanthanum, oxides thereof, zirconium oxide, stabilized or partially stabilized zirconium oxide.

28. The heat insulation layer system of claim 15, wherein the Al₂O₃ layer and/or the heat insulation layer and/or an inner sublayer and/or a bonding layer have a layer thickness in a range of from 0.1 to 1000 μm.

29. The heat insulation layer system of claim 15, wherein the heat insulation layer system comprises a plurality of heat insulation layers and/or a plurality of inner sublayers and/or a plurality of Al₂O₃ layers.

30. The heat insulation layer system of claim 29, wherein the layers are arranged repeatedly from inside to outside in the order inner sublayer, heat insulation layer and Al₂O₃ layer, or are arranged repeatedly in any order.

31. A component comprising the heat insulation layer system of claim 15.

32. The component of claim 31, wherein the component is a component of an aircraft engine.

33. The component of claim 31, wherein the component comprises a metallic or a mixed metallic-ceramic component substrate surface onto which the heat insulation layer system has been applied.

34. The component of claim 31, wherein the component is a component of a combustion chamber or a turbine of an aircraft engine.
